(19) United States
(12) Patent Application Publication
(10) Pub. No.: US 2019/0136959 A1
(43) Pub. Date: May 9, 2019

(54) LOCKING BEARING ASSEMBLY

(71) Applicant: GM GLOBAL TECHNOLOGY OPERATIONS LLC, Detroit, MI (US)

(72) Inventors: Sachin C. Pagare, New Nashik (IN); Jack M. Gayney, Grosse Ile, MI (US); Hun J. Kim, Novi, MI (US)

(21) Appl. No.: 15/807,846

(22) Filed: Nov. 9, 2017

(51) Int. Cl. F16H 57/021; F16C 19/16; F16C 23/08; F16C 33/58; F16H 55/30; F16H 7/06; F16H 37/08; F16H 57/00

(52) U.S. Cl. CPC F16H 57/021; F16C 19/16; F16C 23/086; F16C 33/585; F16C 2326/06; F16H 7/06; F16H 37/0813; F16H 57/0031; F16H 55/30

(57) ABSTRACT

An automotive propulsion system, a final drive assembly, and a bearing assembly are disclosed. The ball bearing assembly includes a bearing race structure having an inner race and an outer race, where the outer race is disposed concentrically about the inner race. A number of rotatable bearing elements (e.g., balls) are disposed between the inner race and the outer race. The bearing race structure has a plurality of threads extending therefrom (from either the outer race or the inner race). The bearing race structure is connected by the plurality of threads to an adjacent structure to prevent relative movement of the bearing race structure with respect to the adjacent structure.

### TECHNICAL FIELD

The present disclosure relates to a bearing assembly with features for retaining the bearing assembly with respect to adjacent components.

### INTRODUCTION

Automotive vehicles include propulsion systems configured to propel the vehicles. The propulsion system may include an internal combustion engine and/or an electric motor/generator, a transmission, and a final drive unit. The final drive unit is configured to transmit torque to the vehicle wheels. For example, the final drive unit may transmit torque from the transmission or from an electric motor/generator to the vehicle wheels. The final drive unit typically includes a differential, which allows the vehicle wheels to rotate at different speeds.

In some propulsion systems, a transmission shaft may rotate about a first axis of rotation, and a final drive shaft may rotate about a second axis of rotation that is offset from the first axis of rotation. The transmission output and the final drive shaft may be connected by a member, such as a chain. In some variations, another rotating shaft connected to the motor/generator may also or alternatively be coupled to the final drive shaft. Endless rotatable members, such as chains or belts, may couple the shafts together, for example, by a sprocket.

A ball bearing assembly is provided to rotatably connect elements of the final drive assembly to a support structure. Typically, the ball bearing assembly is located between rotating member and stationary member. One interface of the bearing assembly with the rotating member typically uses a press fit to prevent relative movements. However, under certain conditions, the bearing assembly may move axially or rotationally within the press fitting between the sprocket bore and bearing outside surface, which is undesirable during transmission operation.

### SUMMARY

The present disclosure provides a bearing assembly, which may be a ball bearing assembly, that has a race threaded to one of the adjacent structures, such as to the sprocket or the stationary case. The threading engagement between the bearing assembly and the adjacent structure prevents the bearing assembly from relative movements with respect to the adjacent structure.

In one form, which may be combined with or separate from the other forms disclosed herein, a bearing assembly is provided that includes a bearing race structure having an inner race and an outer race. The outer race is disposed concentrically about the inner race. A plurality of rotatable bearing elements is disposed between the inner race and the outer race. The bearing race structure has a plurality of threads extending therefrom, and the bearing race structure is connected by the plurality of threads to an adjacent structure to prevent relative movement of the bearing race structure with respect to the adjacent structure.

In another form, which may be combined with or separate from the other forms disclosed herein, a final drive assembly of an automotive propulsion system is provided. The final drive assembly includes a final drive shaft configured to be connected to at least one wheel axle for propelling a motor vehicle and a connection element for connecting the final drive shaft to a propelling shaft. The final drive assembly further includes a bearing assembly configured to rotatably connect the connection element to a stationary structure. The bearing assembly includes a bearing race structure having an inner race and an outer race, the outer race being disposed concentrically about the inner race. A plurality of rotatable bearing elements is disposed between the inner race and the outer race. The bearing race structure has a plurality of threads extending therefrom, and the bearing race structure is connected by the plurality of threads to an adjacent structure to prevent axial movement of the bearing race structure with respect to the adjacent structure. In this case, the adjacent structure, to which the bearing race structure is threaded, can be the connection element or the stationary structure.

In yet another form, which may be combined with or separate from the other forms disclosed herein, an automotive propulsion system is provided that includes a transmission having an output member, a final drive assembly having a final drive shaft, and an endless rotatable member coupling the transmission output member to the final drive shaft. A connection element is coupled to the final drive shaft and to the endless rotatable member. A bearing assembly is included, which is configured to rotatably connect the connection element to a stationary structure. The bearing assembly includes a bearing race structure having an inner race and an outer race, the outer race being disposed concentrically about the inner race. A plurality of rotatable bearing elements is disposed between the inner race and the outer race. The bearing race structure has a plurality of threads extending therefrom, the bearing race structure being connected by the plurality of threads to an adjacent structure to prevent relative movement of the bearing race structure with respect to the adjacent structure. The adjacent structure, to which the bearing race structure is threadingly engaged, may be the connection element. In another variation, the bearing race structure may be threadingly engaged to the stationary structure.

Additional features may optionally be provided, including but not limited to the following: the plurality of threads being a first plurality of threads, the adjacent structure having a second plurality of threads engaged, or threadingly engaged, with the first plurality of threads; wherein the first plurality of threads is disposed on the outer race; the first plurality of threads extending from an outer surface of the outer race; the second plurality of threads being disposed on the connection element; the second plurality of threads extending from an inner surface of the connection element; the inner race having an inner surface that is loose fit to the stationary structure; the adjacent structure (to which the outer race may be threaded) being a first structure, the inner race having an inner surface that is loose fit to a second structure; the plurality of rotatable bearing elements comprising a plurality of balls; the outer race having an inner side that is shaped to partially surround the plurality of balls; the inner race having an outer side that is shaped to partially surround the plurality of balls; the bearing assembly further comprising a cage disposed between the inner and outer races; the cage being configured to position each ball with equal spacing circumferentially; the outer race defining a plurality of pockets configured to receive a torqueing tool for tightening the first plurality of threads into engagement with the second plurality of threads; further comprising an endless rotatable member; wherein the connection element or first structure is a sprocket configured to engage or engaging the endless rotatable member to interconnect the final drive shaft or first rotatable shaft with the propelling shaft, output member, or second rotatable shaft.

The above features and advantages, and other features and advantages, of the present disclosure are readily apparent from the following detailed description and in the appended claims, when taken in connection with the accompanying drawings.

### BRIEF DESCRIPTION OF THE DRAWINGS

FIG. 1 is cross-sectional and schematic side view of a propulsion system having a bearing assembly and a sprocket, in accordance with the principles of the present disclosure;

FIG. 2A is a cross-sectional side view of the bearing assembly and the sprocket of FIG. 1, according to the principles of the present disclosure;

FIG. 2B is a close-up cross-sectional side view of the bearing assembly and the sprocket of FIG. 2A, taken along the outline box 2B, in accordance with the principles of the present disclosure;

FIG. 3A is a perspective view of the bearing assembly of FIGS. 1-2B, according to the principles of the present disclosure;

FIG. 3B is a perspective view of the sprocket of FIGS. 1-2B, in accordance with the principles of the present disclosure;

FIG. 4 is a perspective, cross-sectional view of a portion of the bearing assembly of FIGS. 1-3A, according to the principles of the present disclosure; and

FIG. 5 is a plan see-through view of the bearing assembly of FIGS. 1-3A and 4, in accordance with the principles of the present disclosure.

### DETAILED DESCRIPTION

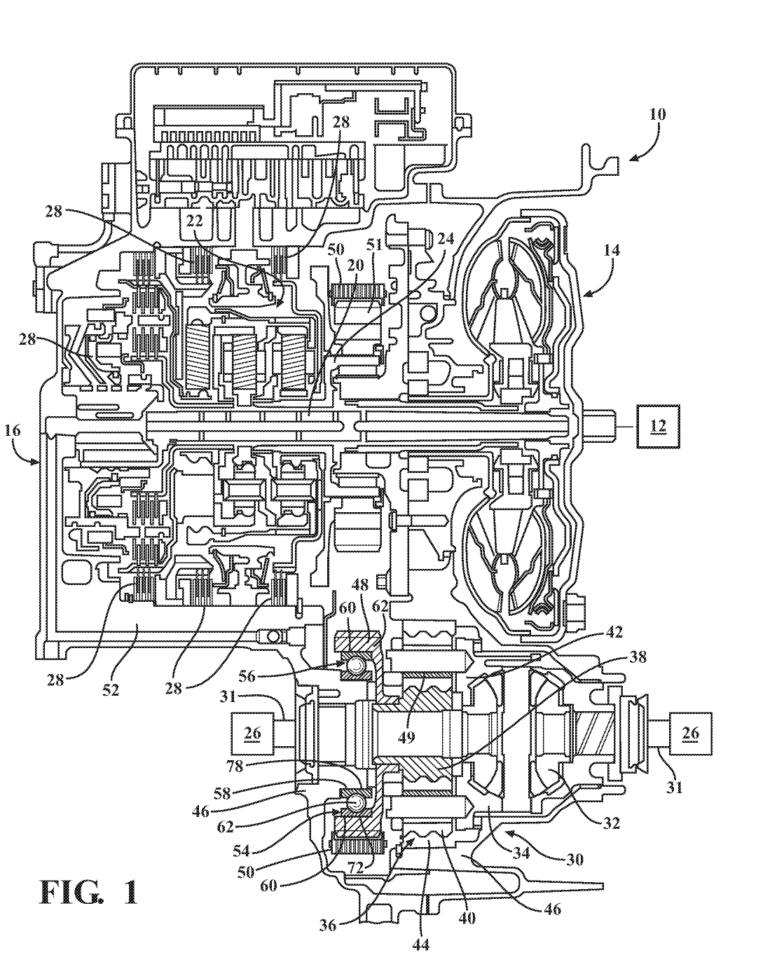

Referring to the drawings, wherein like reference numbers refer to like components throughout the several figures, FIG. 1 illustrates a vehicle propulsion system 10. The propulsion system 10 generally includes an engine 12 interconnected with a torque converter 14 and to a transmission 16. The engine 12 may be a conventional internal combustion engine, a hybrid engine, or any other type of prime mover, without departing from the spirit and scope of the present disclosure. The engine 12 supplies a driving engine output torque to the transmission 16 via the torque converter 14. The driving engine output torque may be transmitted through the torque converter 14 to the transmission 16 through an input shaft 20.

The transmission 16 may be a stepped transmission having planetary gears, a manual transmission, a countershaft transmission, a continuously variable transmission, or an infinitely variable transmission, by way of example. In the illustrated example, the transmission 16 is an automatic transmission having a plurality of shafts and planetary gear sets 22 configured to transmit torque from the input shaft 20 to an output member 24 coupled to a drive sprocket 51 and ultimately to a set of wheels denoted schematically at 26. Torque from the transmission input shaft 20 is communicated through the shafts and planetary gear sets 22 to the drive sprocket 51, where the combinations and connections of the shafts and planetary gear sets 22 can be changed by a plurality of torque transmitting mechanisms 28 to change the ratio of the input shaft 20 to the drive sprocket 51.

The drive sprocket 51 is coupled to a final drive assembly 30, which is further coupled to at least one wheel axis coupled to the wheels 26 through a final drive shaft, such as an axle shaft 31. The final drive assembly 30 may include a differential 32 for allowing the wheels 26 to rotate at different speeds and include a differential housing 34 operatively coupled to a final drive gear assembly 36. The final drive gear assembly 36 may include a sun gear 38 meshed with a plurality of pinion gears 40 that are rotatably connected to a carrier 42. A plurality of needle bearings 49 may be disposed between portions of the carrier 42 and the pinion gears 40. The carrier 42 may be connected to or integrally formed with the differential housing 34. The pinion gears 40 may also be in meshing engagement with a ring gear 44. The ring gear 44 may be fixed to or unitarily formed with a stationary structure or case 46 surrounding the final drive assembly 30.

The final drive gear assembly 36 may also be coupled to a connection element, such as a driven sprocket 48. For example, the driven sprocket 48 may be fixedly connected to the sun gear 38. The driven sprocket 48 may be coupled to the drive sprocket 51 by a gear or an endless rotatable member, such as a belt or chain. In the illustrated example, a chain 50 couples the drive sprocket 51 to the driven sprocket 48 of the final drive assembly 30. The axle shafts 31 are connected to the driven sprocket 48 that engages the chain 50. Thus, torque can be transferred from the drive sprocket 51 and the driven sprocket 48 through the chain 50 to the final drive gear assembly 36 and to the differential housing 34 to ultimately be delivered to the axle shaft 31 and the wheels 26.

In other examples, the propulsion system 10 could also or alternatively include an electric motor (not shown) coupled to the final drive assembly 30, for example, through an endless rotatable member similar to member 50.

The case 46 of the final drive assembly 30 may be attached to the transmission case 52. In addition, a bearing assembly 54 may be used to rotatably connect the driven sprocket 48 to the final drive case 46, for stability. The bearing assembly 54 may be a deep groove ball bearing (DGBB), by way of example.

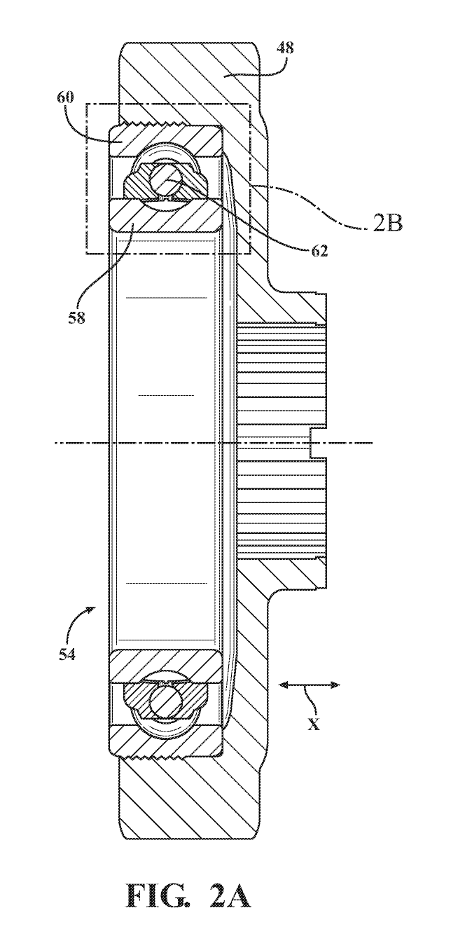

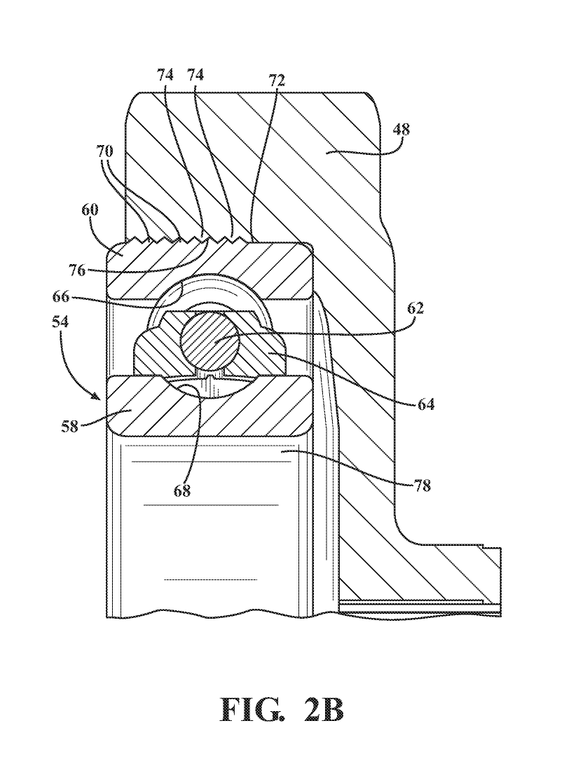

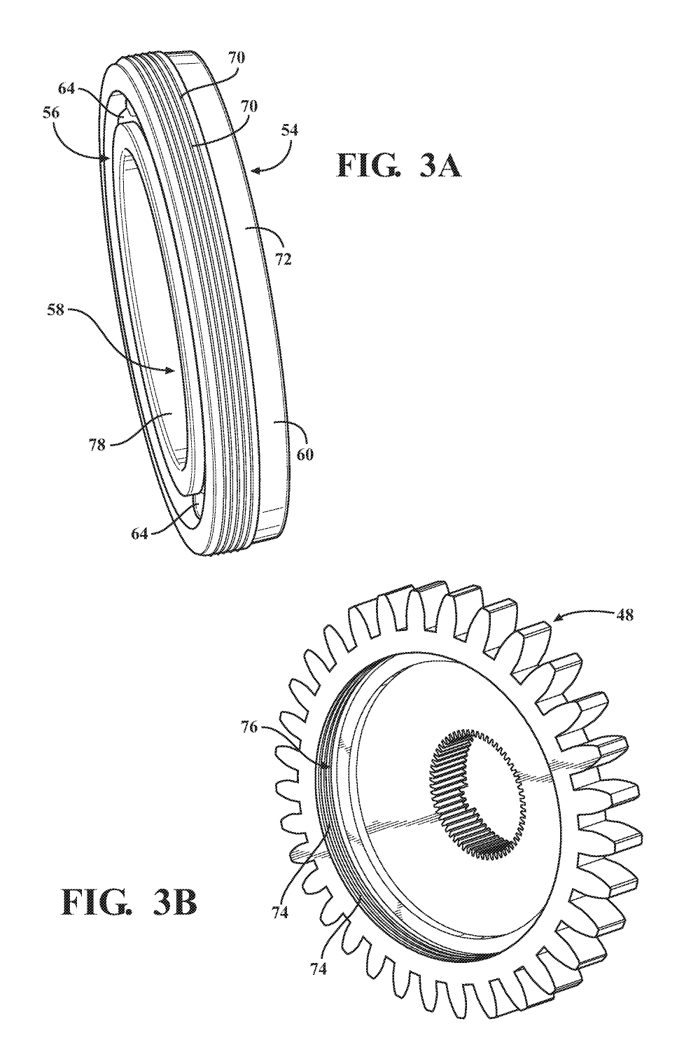

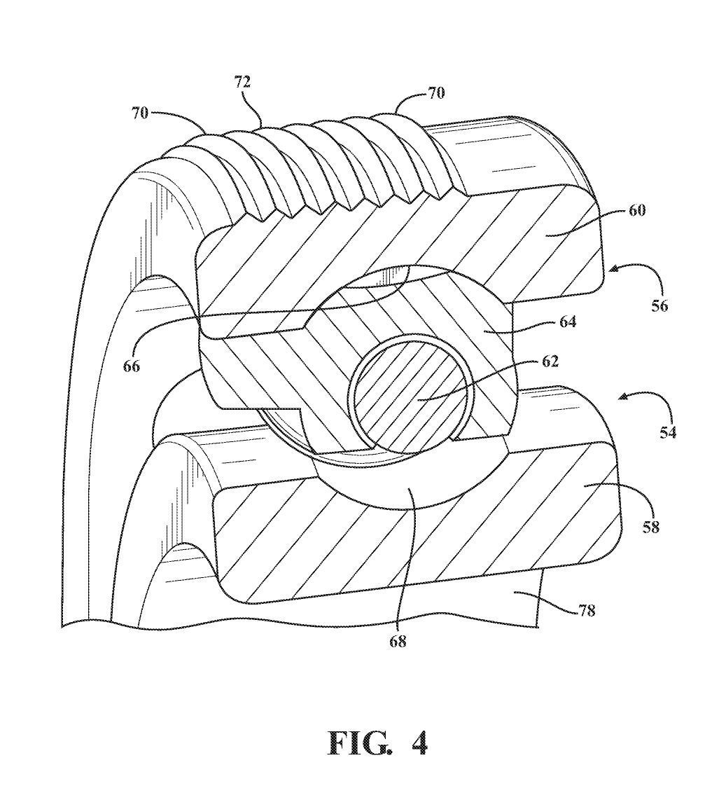

Referring now to FIGS. 1, 2A-2B, 3A-3B and 4, the bearing assembly 54 includes a bearing race structure 56 having an inner race 58 and an outer race 60. The outer race 60 is disposed concentrically about the inner race 58. Rotatable bearing elements, such as balls 62, are disposed between the inner race 58 and the outer race 60. A cage 64 may be disposed between the inner and outer races 58, 60, where the cage 64 is configured to position each ball 62 at equal spacing circumferentially. In some forms, an inner side 66 of the outer race 60 is shaped to partially surround the balls 62, and an outer side 68 of the inner race 58 is shaped to partially surround the balls 62.

The bearing race structure 56 has a plurality of threads 70 extending therefrom. The threads 70 may extend from either the inner race 58 or the outer race 60. In the illustrated example, the plurality of threads 70 is disposed on the outer race 60 and extending from an outer surface 72 of the outer race 60.

A corresponding second mating plurality of threads 74 are disposed on an adjacent structure to secure the bearing race structure 56 to the adjacent structure. The adjacent structure could be the connection element, such as the driven sprocket 48, or the final drive assembly case 46, by way of example. In the illustrated example, the second plurality of threads 74 extends from an inner surface 76 of the driven sprocket 48. The bearing race structure 56 is connected by the first plurality of threads 70 to the second plurality of threads 74 of the driven sprocket 48 to prevent relative movement of the bearing race structure 56, and specifically the bearing outer race 60, with respect to the driven sprocket 48. Thus, the threads 70 that extend from the outer surface 72 of the outer race 60 are engaged, or threadingly engaged, with the threads 74 that extend from the inner surface 76 of the sprocket 48.

The inner race 58 has an inner surface 78 that is loose fit for assembly to the stationary structure, in this case, the final drive case 46. The loose fit turns into a press fit when temperature rises during transmission operation. In the alternative, however, it should be understood that the inner race 58 could be threaded instead of the outer race 60 being threaded, in certain applications. Further, the inner race 58 could be attached to the final drive case 46 in any other suitable manner, without falling beyond the spirit and scope of the present disclosure.

Thus, the use of threads 70, 74 to retain the outer race 60 to the connection element (e.g., driven sprocket 48) eliminates the issue of the bearing race structure 56 relative movements over time. The threads 70, 74 serve as a locking feature to retain the bearing race structure 56 to the surrounding components, and in this case specifically, to the driven sprocket 48.

In addition to eliminating or reducing relative movement of the bearing race structure 56 (in this example, specifically, the outer race 60) with respect to the driven sprocket 48, the bearing assembly 54 has the additional benefit of maintaining the preset clearance between the outer and inner raceway surfaces 66, 68 and each of the balls 62. This is because only one race 58 becomes press fit to the surrounding components when temperature rises, so any reduction in clearance upon assembly is reduced or eliminated.

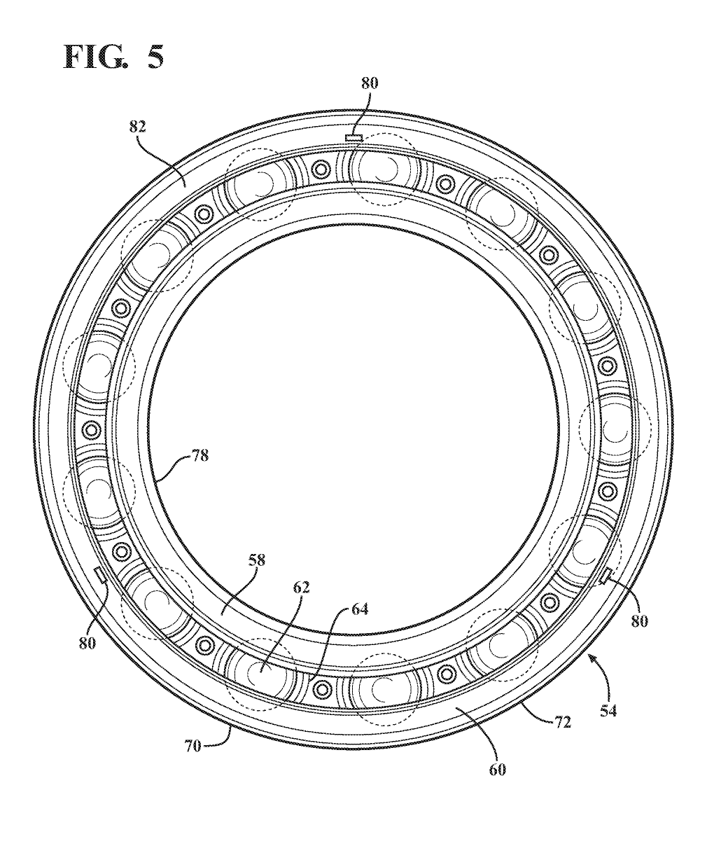

Referring now to FIG. 5, the ball bearing assembly 54 is shown in a side see-through schematic view. The outer race 60 defines a plurality of pockets 80 formed in a side surface 82 of the outer race 60. In this example, the pockets 80 are three in number and spaced equidistant from each other; however, any desired number of pockets 80 or placement of the pockets 80 could be used. To assemble the bearing outer race 60 to the driven sprocket 48, the threads 70 of the outer race 60 need to be threaded onto the threads 74 of the driven sprocket 48. A torqueing tool (not shown) may be inserted into the pockets 80 to rotate the outer race 60 with respect to the driven sprocket 48 to tighten the threads 70 of the outer race 60 into engagement with the threads 74 of the driven sprocket 48.

Though specifically shown in an automotive propulsion system 10, the ball bearing assembly 54 may be used without the propulsion system 10, such as in other applications and fields. The illustrated threads 70, 74 may be supplied as course threads, such as M105×1.5−6G, but this is merely due to the corresponding size of the driven sprocket 48 and bearing assembly 54 used in the illustrated example (for example, the illustrated outer race 60 may have a diameter of 100 mm), and other size threads could be used depending on the size of the components in the particular application.

The detailed description and the drawings or figures are shown as an example, but any combination or variation of the disclosure is permissible, with the scope of the invention being defined solely by the claims. Various alternative designs and embodiments may be applied, without falling beyond the spirit and scope of the present disclosure.

What is claimed is:

1. A bearing assembly comprising:
a bearing race structure having an inner race and an outer race, the outer race being disposed concentrically about the inner race; and
a plurality of rotatable bearing elements disposed between the inner race and the outer race,
wherein the bearing race structure has a plurality of threads extending therefrom, the bearing race structure being connected by the plurality of threads to an adjacent structure to prevent relative movement of the bearing race structure with respect to the adjacent structure.

2. The bearing assembly of claim 1, the plurality of threads being a first plurality of threads, the adjacent structure having a second plurality of threads engaged with the first plurality of threads.

3. The bearing assembly of claim 2, wherein the first plurality of threads is disposed on the outer race, the first plurality of threads extending from an outer surface of the outer race.

4. The bearing assembly of claim 3, the adjacent structure being a first structure, the inner race having an inner surface that is loose fit to a second structure during assembly, the inner surface configured to become press fit as temperature rises during operation.

5. The bearing assembly of claim 4, the plurality of rotatable bearing elements comprising a plurality of balls, wherein the outer race has an inner side that is shaped to partially surround the plurality of balls, and the inner race has an outer side that is shaped to partially surround the plurality of balls.

6. The bearing assembly of claim 5, wherein the first structure is a sprocket configured to engage a rotatable member to interconnect a first rotatable shaft with a second rotatable shaft.

7. The bearing assembly of claim 6, further comprising a cage disposed between the inner and outer races, the cage being configured to position each ball of the plurality of balls at equidistant spacing, the outer race defining a plurality of pockets configured to receive a torqueing tool for tightening the first plurality of threads into engagement with the second plurality of threads.

8. A final drive assembly of an automotive propulsion system, the final drive assembly comprising:
a final drive shaft configured to be connected to at least one wheel axle for propelling a motor vehicle;
a connection element for connecting the final drive shaft to a propelling shaft; and
a bearing assembly configured to rotatably connect the connection element to a stationary structure, the bearing assembly comprising:
a bearing race structure having an inner race and an outer race, the outer race being disposed concentrically about the inner race; and
a plurality of rotatable bearing elements disposed between the inner race and the outer race,
wherein the bearing race structure has a plurality of threads extending therefrom, the bearing race structure being connected by the plurality of threads to an adjacent structure, the adjacent structure being one of the connection element and the stationary structure.

9. The final drive assembly of claim 8, the plurality of threads being a first plurality of threads, the adjacent structure having a second plurality of threads engaged with the first plurality of threads to prevent relative movement of the bearing race structure with respect to the adjacent component.

10. The final drive assembly of claim 9, wherein the first plurality of threads is disposed on the outer race, the first plurality of threads extending from an outer surface of the outer race, and the second plurality of threads is disposed on the connection element, the second plurality of threads extending from an inner surface of the connection element.

11. The final drive assembly of claim 10, the inner race having an inner surface that is loose fit to the stationary structure during assembly, the inner surface configured to become press fit as temperature rises during operation.

12. The final drive assembly of claim 11, the plurality of rotatable bearing elements comprising a plurality of balls, wherein the outer race has an inner side that is shaped to partially surround the plurality of balls, and the inner race has an outer side that is shaped to partially surround the plurality of balls.

13. The final drive assembly of claim 12, further comprising an endless rotatable member, wherein the connection element is a sprocket engaging the endless rotatable member to interconnect the final drive shaft with the propelling shaft.

14. The final drive assembly of claim 13, the bearing assembly further comprising a cage disposed between the inner and outer races, the cage being configured to position each ball of the plurality of balls at equal distance circumferentially, the outer race defining a plurality of pockets configured to receive a torqueing tool for tightening the first plurality of threads into engagement with the second plurality of threads.

15. An automotive propulsion system comprising:
a transmission having an output member;
a final drive assembly having a final drive shaft;
an endless rotatable member coupling the output member to the final drive shaft;
a connection element coupled to the final drive shaft and to the endless rotatable member; and
a bearing assembly configured to rotatably connect the connection element to a stationary structure, the bearing assembly comprising:
a bearing race structure having an inner race and an outer race, the outer race being disposed concentrically about the inner race; and
a plurality of rotatable bearing elements disposed between the inner race and the outer race,
wherein the bearing race structure has a plurality of threads extending therefrom, the bearing race structure being connected by the plurality of threads to an adjacent structure to prevent relative movement of the bearing race structure with respect to the adjacent structure, the adjacent structure being one of the connection element and the stationary structure.

16. The automotive propulsion system of claim 15, the plurality of threads being a first plurality of threads, the adjacent structure having a second plurality of threads threadingly engaged with the first plurality of threads.

17. The automotive propulsion system of claim 16, wherein the first plurality of threads is disposed on the outer race, the first plurality of threads extending from an outer surface of the outer race, and the second plurality of threads is disposed on the connection element, the second plurality of threads extending from an inner surface of the connection element.

18. The automotive propulsion system of claim 17, the inner race having an inner surface that is initially loose fit to the stationary structure, the inner surface configured to become press fit as temperature rises.

19. The automotive propulsion system of claim 18, the plurality of rotatable bearing elements comprising a plurality of balls, wherein the outer race has an inner side that is shaped to partially surround the plurality of balls, and the inner race has an outer side that is shaped to partially surround the plurality of balls, the bearing assembly further comprising a cage disposed between the inner and outer races, the cage being configured to position each ball of the plurality of balls at equal distance circumferentially, the outer race defining a plurality of pockets configured to receive a torqueing tool for tightening the first plurality of threads into engagement with the second plurality of threads.

20. The automotive propulsion system of claim 19, wherein the connection element is a sprocket engaging the endless rotatable member.
